(19) United States
(12) Patent Application Publication
(10) Pub. No.: US 2004/0210868 A1
(43) Pub. Date: Oct. 21, 2004

(54) Icons and icon representation of process steps for graphic visualization of task-oriented steps

(75) Inventors: Matthias Dutsch, Moglingen (DE); Klaus Hertinger, Erlangen (DE); Timo Pallas, Stuttgart (DE); Martin Seithe, Erlangen (DE); Klaus Steinbrucker, Waldenbuch (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 10/789,420

(22) Filed: Feb. 27, 2004

(30) Foreign Application Priority Data
Feb. 27, 2003 (DE) 103 08 816.4

(51) Int. Cl. G06F 9/44

(52) U.S. Cl. 717/113

(57) ABSTRACT

Icons for graphic visualization of task-oriented steps in industrial control processes as well as a corresponding icon representation of process steps of parts program in machine tools and production machines are described. The icons are composed of at least one graphic symbol and at least one placeholder, wherein a size of the placeholder is representative of the duration of a task-oriented process step. The individual steps of parts programs of the machine can be visualized by arranging the icons in form of rows and columns and each icon graphically visualizes an individual task-oriented step of a parts program. Each row (column) is associated with a particular parts program and a column (row) width of an icon in said row (column) represents a duration of the task-oriented process step for said parts program. In this way, the structure of part programs and the associated process steps can be readily graphically visualized.

### CROSS-REFERENCES TO RELATED APPLICATIONS

This application claims the priority of German Patent Application, Serial No. 103 08 816.4, filed Feb. 27, 2003, pursuant to 35 U.S.C. 119(a)-(d), the disclosure of which is incorporated herein by reference.

### BACKGROUND OF THE INVENTION

The present invention relates to icons for graphic visualization of task-oriented steps in industrial control processes as well as to icon representation of process steps for graphic visualization of task-oriented steps of parts program in machine tools and production machines. In the context of this application, the term “production machine” is used in a generic sense and also includes robots which generally follow the concepts outlined here.

When a workpiece is machined with a machine tool or production machine, wherein production machines also include robots, axles and/or spindles can be moved during the production process. The axles and/or spindles, which here describe a relative movement between a tool and a workpiece, are referred to as so-called machining units. In the production process, the axles and/or spindles are assigned to a so-called channel. The move instructions to be transmitted to the machining unit are defined and described in the channel in the form of a parts program. The parts program is transmitted inside a numerical controller of the machine to an interpreter which converts the parts program to a corresponding machine code.

For increasing the productivity, machine tools or production machines frequently include several machining units which can be moved simultaneously. These machine tools or production machines are referred to as multi-channel machines and can include several independent parts programs defining a number of relative movements between workpiece(s) and tool(s) that are simultaneously interpreted and executed by multiple channels, thereby allowing simultaneous machining of one or more of the workpieces. Each channel can have a dedicated parts program.

The parts program typically consists of a standard ASCII source code in conformance with DIN 66025/ISO as well as optional additional manufacturer-specific or machine-specific expansions and/or upgrades. The parts programs are typically displayed and processed in ASCII format using an editor, in particular a text editor. Also known are programming systems for programming the machine or generating parts programs, whereby the programming systems can be used to generate specific task-oriented parts programs in a so-called task-oriented step diagram which can be graphically displayed to the user. A step diagram facilitates provides a structured view and processing of the various parts programs which facilitates programming and operating the machine.

Multi-channel machines typically require coordination, in particular a temporal coordination, between the various parts programs.

It would therefore be desirable and advantageous to provide a display and method for an easily understandable structured graphic visualization of process flows and the associated interdependencies, in particular temporal process flows and interdependencies, of parts programs or task-oriented steps in industrial control processes.

### SUMMARY OF THE INVENTION

According to one aspect of the present invention, an icon for graphic visualization of task-oriented steps in industrial control processes is disclosed wherein the icon is composed of at least one graphic symbol and at least one placeholder, wherein a size of the placeholder is representative of the duration of a task-oriented process step.

According to another aspect of the invention, in a method for graphic visualization of task-oriented steps of parts programs in machine tools or production machines with icons, wherein the icons are arranged in form of rows and columns and each icon graphically visualizes an individual task-oriented step of a parts program, each row is associated with a particular parts program and a column width of an icon in the row represents a duration of the task-oriented process step for the parts program. Alternatively, each column is associated with a particular parts program and a row width of an icon in the column represents a duration of the task-oriented process step for the parts program.

According to one advantageous feature of the invention, a placeholder in the form of a frame provides an easily understandable view as well as an exact boundary to adjacent icons. A line or an arrow are additional examples particularly simple placeholders.

According to another feature of the invention, the icon can display an actual state of a task-oriented process step as a change in color and/or size and/or type of the graphic symbol and/or a change in a line thickness and/or a line type of the placeholder. This allows a particularly clear representation of the actual state of a step.

The icon according to the invention is particularly suited for graphic visualization of task-oriented steps of parts programs in machine tools or production machines, since these applications benefit from a structured and clear graphic visualization of the temporal process steps as well as of possible mutual dependencies of parts programs.

According to other advantageous feature of the invention, the icons can include at least one graphic symbol and at least one placeholder, wherein the size of the placeholder is representative of the duration of a task-oriented process step. The user can then easily graphically recognize the relationship between the size of the placeholder and the duration of the step.

In another advantageous embodiment, when the user selects an icon, the corresponding parts program associated with the row or column can be indicated in ASCII code or as a graphic visualization of the process step. This allows the user to quickly and readily recall and subsequently edit the corresponding parts program.

According to another advantageous feature of the invention, the duration of a task-oriented process step can be referenced to a common time axis. This provides a particularly clear graphic visualization of the temporal relationship between process steps.

According to yet another advantageous feature of the invention, the icons can be displayed in a normalized or synchronized form. A visualization of steps in normalized and/or synchronized form provides a particularly clear representation of the individual steps and/or the production process.

According to yet another advantageous feature of the invention, the mutual dependency of the parts programs can be visualized by synchronization lines that connect the icons across different parts programs. This provides a particularly clear graphic visualization of the mutual dependencies of parts programs.

According to yet another advantageous feature of the invention, the duration of a task-oriented process step can be indicated in form of numerical values.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an icon with a graphic symbol for a step and a placeholder;

FIG. 2 shows the icon of FIG. 1, with the placeholder depicting a different step duration;

FIG. 3 shows schematically a screen display with a first embodiment of icons representing process steps according to the invention; and

FIG. 4 shows schematically a screen display with an alternative embodiment of icons representing process steps according to the invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

This is one of two applications both filed on the same day. Both applications deal with related inventions. They are commonly owned and have the same inventive entity. Both applications are unique, but incorporate the other by reference. Accordingly, the following U.S. patent application is hereby expressly incorporated by reference: “METHOD FOR GENERATING AND VISUALIZING A TASK-ORIENTED STEP REPRESENTATION”.

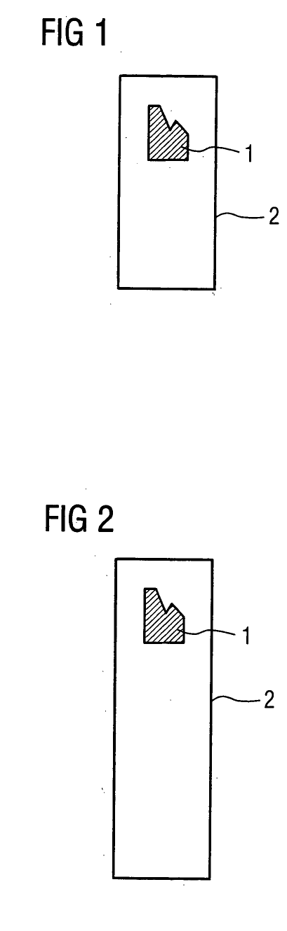

Turning now to the drawing, and in particular to FIG. 1, there is shown an exemplary embodiment of an icon according to the invention. The icon includes a symbol 1 representing a task-oriented step to be visualized and a placeholder 2 which in the depicted example is shown as a frame 2 surrounding the symbol 1. The size (e.g., length and/or width) of the placeholder or frame 2 can be to represent the duration of the corresponding step, so that the placeholder has a visual relationship with the duration of the corresponding step. The size of the frame 2 can be adapted to reflect the duration of the step. In the depicted embodiment, the length of the frame represents the duration of the process step. A short frame represents a short step duration, wherein as a longer frame represents a correspondingly longer step duration.

FIG. 2 shows the corresponding icon with an elongated frame. For example, the symbol 1 depicted in FIG. 1 and FIG. 2 can symbolize a step with the designation “Smooth Surface”, with the step depicted in FIG. 2 having a longer duration than the step depicted in FIG. 1. Of course, other embodiments of the placeholder can also be used. Instead of the frame depicted in FIGS. 1 and 2 as a placeholder, placeholders can also be represented by, for example, a line or an arrow placed, for example, below the symbol 1, wherein the length of the line or the arrow reflects the duration of the step. The frame also need not necessarily be located close the symbol; for example, the frame or a line associated with the symbol can also be arranged below the symbol. In the embodiment depicted in FIGS. 1 and 2, the size and form of the symbol itself were not changed to reflect the step duration; instead, the symbol was left identical. However, it will be understood that the symbol itself in addition to the frame can also be changed to match the step duration. It would be feasible, for example, to use a smaller symbol when steps are shorter than a certain time duration. Likewise, with particularly long steps, the symbol could be slightly enlarged.

The actual state of a step can also be displayed or visualized for the user as a color change and/or as a changed line width and/or as a changed line type and/or as a change in the size of the graphic symbol and/or of the placeholder. For example, the step currently performed by the machine or edited by the user or programmer, can be displayed as the actual state in the form of a color change of the graphic symbol and/or by a different width of the placeholder.

The icons according to the invention can not only be used for graphically visualizing task-oriented steps of parts program in machine tools or production machines, but can also be applied in general in industrial control processes, where the duration of a task, process step or operating step should be visualized to a user graphically in a simple and clear manner.

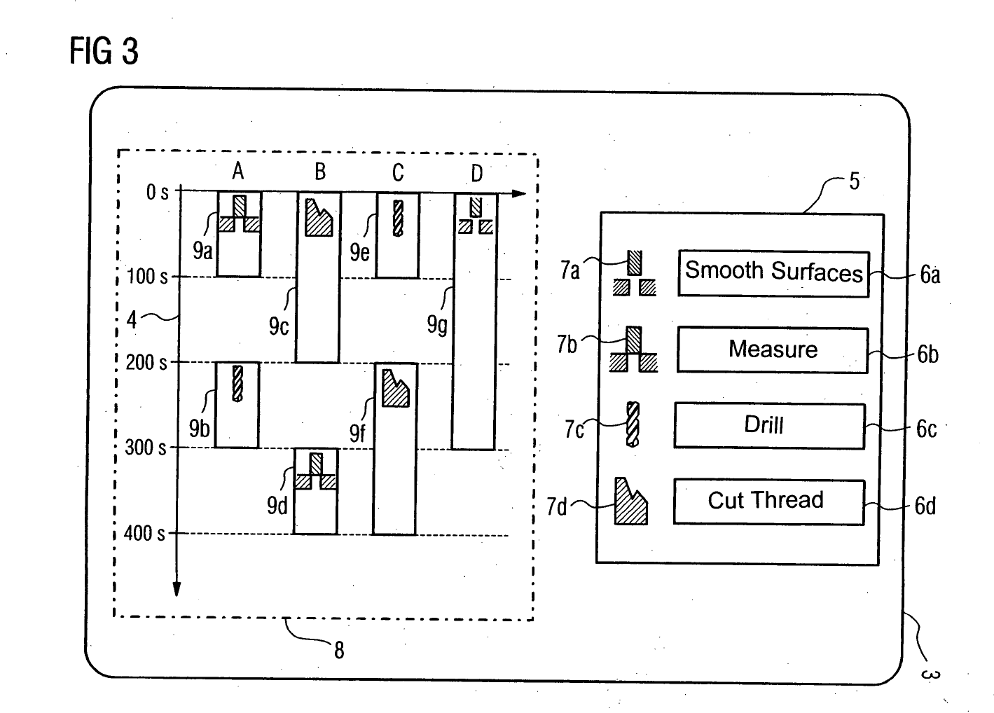

FIG. 3 depicts schematically an exemplary display image 3 which includes an icon representation 8 of process steps according to the invention. The icon representation 8 in FIG. 3 graphically displays the individual steps of four different parts programs A, B, C and D of a multi-channel machine. Icons 9a, 9b, 9c, 9d, 9e, 9f and 9g, are associated with the various parts programs A, B, C and D. Each vertical column represents a different parts program A, B, C or D. The icons for each parts programs A, B, C and D are consecutively arranged in the corresponding parts-program-related columns. Since it parts program can include a large number of steps, only a small segment of the respective parts program is shown in the exemplary display image 3. For example, the icons 9a and 9b of the parts program A which represent the steps “Measure” and “Drill” are shown in the corresponding vertical column. Likewise, the icons 9c and 9d are shown for the parts program B, the icons 9e and 9f for the parts program C, and the icons 9g for the parts program D. The symbol of the icon 9d represents, for example, a step with the designation “Measure”, whereas for example the symbol of the icon 9g symbolizes a step with the designation “Smooth Surface”.

As described above with reference to FIGS. 1 and 2, the size of the frame in the embodiment is adapted to the duration of the corresponding step. For example, execution of step 9a of the parts program A may require 100 seconds, whereas execution of step 9g of the parts program D may require 300 seconds. The duration of the other steps is similarly indicated by the size of the corresponding icons 9b, 9c, 9d, 9e and 9f. A temporal relationship between the icons and the underlying steps of the individual parts programs can be displayed to the user by using a common time axis 4. They user can, on one hand, directly read the duration of a step based on the size or the vertical length of the frame and, on the other hand, read directly on the time axis when the corresponding step begins and ends. The frame of the icon 9f, for example, indicates that the corresponding step—in the present example “Cut Thread”—has a duration of 200 seconds. The corresponding step starts at the time 200 seconds and ends at the time 400 seconds. With displaying the process steps as an icon diagram 8 according to the invention, the user can then easily and immediately recognize that in the parts program A the step having the designation “Drill” and represented by the icon 9b is performed in parallel from the 200^{th} seconds to the 300^{th} second with the aforementioned step “Cut Thread” of the parts program C which is represented by the icon 9f. This way, the icon representation of process steps according to the invention provides these user with an easily understandable representation of the temporal process flow, dependencies and temporal relationships between the parts programs.

By selecting an icon, e.g. the icon 9b, with the help of cursor keys or a mouse, the parts program A associated with the corresponding column can be displayed, as selected by the user, for example, in a new window 5 in ASCII code or as a sequence of process steps. In the depicted embodiment, the icon 9b of the parts program A is selected so that the process steps of parts program A are visualized in window 5, with the icon 9b representing the step 6c indicated by the symbol 7c. Likewise, the icon 9a represents the step 6b with the symbol 7b. The steps 6a and 6d are no longer shown in the icon diagram 8 of the process steps due to the limited size of the display. However, the user can scroll the window 5 to display these process steps. The steps indicated in window 5 and the icons visualized in the icon representation of the process steps are synchronized with each other; for example, when selecting the icon 9b, the associated step 6c is displayed approximately in the same row as icon 9b. With this approach, individual steps of the various parts programs can be easily accessed with the icon representation 8 of the process steps according to the invention. By using a special symbol, e.g. a clock symbol to indicate a so-called wait step, the icon representation 8 of the process steps can also directly visualize the interdependencies of parts programs. For example, it may be required that a parts program should only be continued when another parts program has been executed up to a specified step.

Interdependencies of parts program can also be visualized by so-called synchronization lines. These are graphic lines that connect the individual icons with each other across different parts programs to specifically visualize to the user existing relationships.

In addition to provide a time-related icon representation of process steps, where the frame of the icons is representative of the step duration, the icon representation 8 of the process steps can also be displayed in a normalized or synchronized manner. In the normalized or synchronized representation of the icons or the icon representation of process steps, each icon has an identical frame independent of the step duration. In the normalized representation, the individual icons of a corresponding parts program are depicted in the column associated with that parts program consecutively without a temporal reference.

The icon representation of process steps in the synchronized representation corresponds in principle to the normalized icon representation of process steps, except that if a parts program has more steps and/or a greater number of icons that another parts program within those steps where the parts programs are to be synchronized and/or coordinated, then empty icons are added in the icon representation of process steps to that parts program that has a smaller number of steps or icons. Empty icons are hereby icons that have only a frame, but do not contain a symbol.

The icon representation of process steps also offers the possibility to combine several icons into a higher level icon with a corresponding symbol. This enables the design of hierarchical icon structures. The icons can also be displayed in form of an exploded view, whereby all icons are displayed, or in an imploded view, where only the icons of, for example, a first hierarchical plane are shown.

The window 5 can also be executed on an editor, so that the user can directly edit the individual steps in window 5 or the underlying ASCII code by clicking on a step.

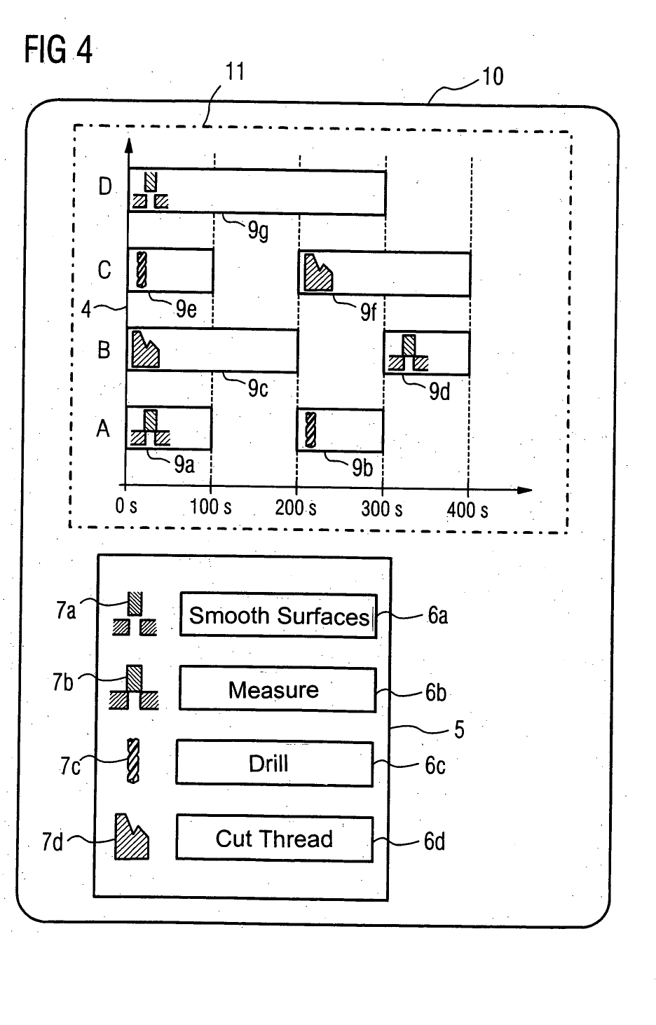

FIG. 4 shows an alternative embodiment of the icon representation of process steps of FIG. 3, displaying an alternative image 10 of the icon representation 11 of process steps. The icon representation 11 of process steps of FIG. 4 is substantively identical with the icon representation 8 of process steps of FIG. 3, except that the icons for the different parts program A, B, C and D are sequentially arranged horizontally in rows instead of columns. Moreover, the window 5 of FIG. 4 is arrange below the icon representation 11 of process steps, whereas the window 5 in FIG. 3 is located next to the icon representation 8 of process steps.

It should be mentioned at this point that the step duration and/or the instructions can also be indicated as numerical values in the displayed image in addition to indicating the duration with the icons. Instructions refer hereby to programming instructions of a parts program written in ASCII source code. A step is typically a combination of several instructions.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An icon for graphic visualization of task-oriented steps in industrial control processes, the icon comprising at least one graphic symbol and at least one placeholder, wherein a size of the placeholder is representative of the duration of a task-oriented process step.

2. The icon of claim 1, wherein the placeholder comprises at least one of a frame, a line and an arrow.

3. The icon of claim 1, wherein the icon displays an actual state of a task-oriented process step as at least one of a change in color, size and type of the at least one graphic symbol and a change in a line thickness and a line type of the placeholder.

4. Use of the icon of claim 1 for graphic visualization of the task-oriented process steps of parts programs in machine tools or production machines.

5. A method for graphic visualization of task-oriented steps of parts programs in machine tools or production machines with icons, wherein the icons are arranged in form of rows and columns and each icon graphically visualizes an individual task-oriented step of a parts program, wherein each row is associated with a particular parts program and a column width of an icon in said row represents a duration of the task-oriented process step for said parts program, or alternatively, each column is associated with a particular parts program and a row width of an icon in said column represents a duration of the task-oriented process step for said parts program.

6. The method of claim 5, wherein the icons comprise at least one graphic symbol and at least one placeholder, wherein a size of the placeholder is representative of the duration of a task-oriented process step.

7. The method of claim 5, wherein the placeholder comprises at least one of a frame, a line and an arrow.

8. The method of claim 5, wherein through selection of an icon by a user, the corresponding parts program associated with the row or column is indicated in ASCII code or as a step visualization.

9. The method of claim 5, wherein the duration of a task-oriented process step is referenced to a common time axis.

10. The method of claim 5, wherein the icons are displayed in a normalized or synchronized form.

11. The method of claim 5, wherein a mutual dependency of the parts programs is visualized by synchronization lines that connect the icons across different parts programs.

12. The method of claim 5, wherein the duration of a task-oriented process step is indicated in form of numerical values.
